(19) United States
(12) Patent Application Publication
(10) Pub. No.: US 2026/0244358 A1
(43) Pub. Date: Aug. 20, 2026

(54) PROGRESSIVE LOG-LIKELIHOOD RATIO GENERATION BASED ON AGGREGATING HARD READS IN MEMORY DEVICES

(71) Applicant: SK hynix Inc., Icheon-si (KR)

(72) Inventors: Pengfei Huang, San Jose, CA (US); Fan Zhang, Fremont, CA (US); Hongwei Duan, Cupertino, CA (US)

(21) Appl. No.: 19/054,208

(22) Filed: Feb. 14, 2025

(51) Int. Cl. G06F 3/06

(52) U.S. Cl. CPC G06F 3/0655; G06F 3/0604; G06F 3/0679

(57) ABSTRACT

Systems and methods for improving performance of a decoder in a memory device are described. An example method includes generating, based on two noisy codewords from a hard read and a hard re-read of a transmitted codeword, a combined log-likelihood ratio (LLR) sequence. The method further includes determining a soft decoding operation on the combined LLR sequence is unsuccessful, and receiving additional noisy codewords, where each additional noisy codeword corresponds to another hard re-read of the transmitted codeword. For each additional noisy codeword, the method includes (a) computing its checksum, (b) determining, based on the checksum, LLR metric values, (c) generating an LLR sequence based thereupon, (d) updating, based on the LLR sequence, the combined LLR sequence, and (e) performing the soft decoding operation on the combined LLR sequence. An example system includes one or more processors configured to implement the above-mentioned method.

### TECHNICAL FIELD

This patent document generally relates to non-volatile memory devices, and more specifically, to low-density parity-check (LDPC) codes used in non-volatile memory devices.

### BACKGROUND

Data integrity is a critical feature for any data storage device and data transmission. Bit errors, which occur when individual bits of data are incorrectly altered during storage or transmission, can significantly compromise data integrity in solid state memory storage (e.g., NAND flash) devices. These errors can result from various factors such as electrical interference, wear and tear of memory cells, or manufacturing defects. When bit errors occur, the data read from the solid state drive (SSD) may not match the data originally written, leading to corrupted files, application errors, and potential data loss. To mitigate the impact of bit errors, SSDs employ error detection and correction mechanisms like error correction codes (ECCs), which can identify and correct a certain number of bit errors. However, if the number of errors exceeds the correction capability of the ECCs, data integrity is compromised, underscoring the importance of robust error management strategies in maintaining the reliability and accuracy of stored data.

### SUMMARY

Embodiments of the disclosed technology relate to methods and systems that improve performance of a memory device that uses a low-density parity check (LDPC) code as its error correcting code. In some examples, generating log-likelihood ratio (LLR) metrics by utilizing information from previous hard reads for soft decoding improves the correction capability of the LDPC decoder.

In one example, a method for improving performance of an LDPC decoder in a memory device is described. The method includes generating, based on two noisy codewords corresponding to a first hard read and a first hard re-read of a transmitted codeword, a combined log-likelihood ratio (LLR) sequence. The method further includes determining a soft decoding operation on the combined LLR sequence is unsuccessful, and receiving one or more additional noisy codewords, where each additional noisy codeword corresponds to another hard re-read of the transmitted codeword. For each additional noisy codeword in the one or more additional noisy codewords, the method includes (a) computing a checksum of an additional noisy codeword, (b) determining, based on using the checksum to index into a first lookup table that maps a checksum value to LLR metric values, a first LLR metric indicative of a bit being zero-valued and a second LLR metric indicative of the bit being one-valued, (c) generating an LLR sequence by applying the first LLR metric or the second LLR metric to each element of the additional noisy codeword, (d) updating, based on the LLR sequence, the combined LLR sequence, and (e) performing the soft decoding operation on the combined LLR sequence to generate a candidate version of the transmitted codeword.

In another example, the methods may be embodied in the form of an apparatus that includes a processor and a memory coupled to the processor.

In yet another example, the methods may be embodied in the form of processor-executable instructions and stored on a computer-readable program medium.

The subject matter described in this patent document can be implemented in specific ways that provide one or more of the following features.

### BRIEF DESCRIPTION OF THE DRAWINGS

FIG. 1 illustrates an example of a memory system.

FIG. 2 is an illustration of an example non-volatile memory device.

FIG. 3 is an example diagram illustrating the cell voltage level distribution (Vₜₕ) of a non-volatile memory device.

FIG. 4 is another example diagram illustrating the cell voltage level distribution (Vₜₕ) of a non-volatile memory device.

FIG. 5 is an example diagram illustrating the cell voltage level distribution (Vₜₕ) of a non-volatile memory device before and after program interference.

FIG. 6 is an example diagram illustrating the cell voltage level distribution (Vₜₕ) of a non-volatile memory device as a function of the reference voltage.

FIG. 7 is an example diagram illustrating the seven soft read channels of a single-level cell (SLC) NAND.

FIG. 8 illustrates an example workflow for a progressive log likelihood ratio (LLR) generation and decoding, in accordance with the disclosed technology.

FIG. 9 illustrates a flowchart of an example method for improving the performance of a low-density parity check (LDPC) decoder in a memory device.

FIG. 10 is an example diagram illustrating a storage device that can be configured to implement the described embodiments.

### DETAILED DESCRIPTION

Semiconductor memory devices may be volatile or nonvolatile. The volatile semiconductor memory devices perform read and write operations at high speeds, while contents stored therein may be lost at power-off. The nonvolatile semiconductor memory devices may retain contents stored therein even at power-off. The nonvolatile semiconductor memory devices may be used to store contents, which must be retained regardless of whether they are powered.

With an increase in a need for a large-capacity memory device, a multi-level cell (MLC) or multi-bit memory device storing multi-bit data per cell is becoming more common. However, memory cells in an MLC non-volatile memory device must have threshold voltages corresponding to four or more discriminable data states in a limited voltage window. For improvement of data integrity in non-volatile memory devices, the levels, and distributions of read voltages for discriminating the data states must be adjusted over the lifetime of the memory device to have optimal values during read operations and/or read attempts.

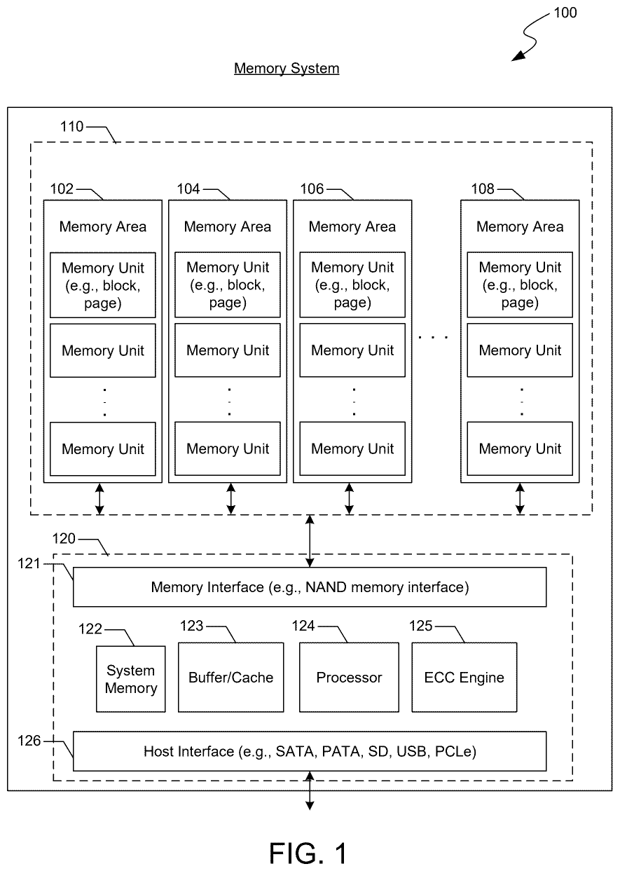

FIGS. 1-6 overview a non-volatile memory system (e.g., a flash-based memory, NAND flash) in which embodiments of the disclosed technology may be implemented.

FIG. 1 is a block diagram of an example of a memory system 100 implemented based on some embodiments of the disclosed technology. The memory system 100 includes a memory module 110 that can be used to store information for use by other electronic devices or systems. The memory system 100 can be incorporated (e.g., located on a circuit board) in other electronic devices and systems. Alternatively, the memory system 100 can be implemented as an external storage device such as a USB flash drive and a solid-state drive (SSD).

The memory module 110 included in the memory system 100 can include memory areas (e.g., memory arrays) 102, 104, 106, and 108. Each of the memory areas 102, 104, 106, and 108 can be included in a single memory die or in multiple memory dice. The memory die can be included in an integrated circuit (IC) chip.

Each of the memory areas 102, 104, 106, and 108 includes a plurality of memory cells. Read, program, or erase operations can be performed on a memory unit basis. Thus, each memory unit can include a predetermined number of memory cells. The memory cells in a memory area 102, 104, 106, and 108 can be included in a single memory die or in multiple memory dice.

The memory cells in each of memory areas 102, 104, 106, and 108 can be arranged in rows and columns in the memory units. Each of the memory units can be a physical unit. For example, a group of a plurality of memory cells can form a memory unit. Each of the memory units can also be a logical unit. For example, the memory unit can be a block or a page that can be identified by a unique address such as a block address or a page address, respectively. For another example, wherein the memory areas 102, 104, 106, and 108 can include computer memories that include memory banks as a logical unit of data storage, the memory unit can be a bank that can be identified by a bank address. During a read or write operation, the unique address associated with a particular memory unit can be used to access that particular memory unit. Based on the unique address, information can be written to or retrieved from one or more memory cells in that particular memory unit.

The memory cells in the memory areas 102, 104, 106, and 108 can include non-volatile memory cells. Examples of non-volatile memory cells include flash memory cells, phase change random-access memory (PRAM) cells, magnetoresistive random-access memory (MRAM) cells, or other types of non-volatile memory cells. In an example implementation where the memory cells are configured as NAND flash memory cells, the read or write operation can be performed on a page basis. However, an erase operation in a NAND flash memory is performed on a block basis.

Each of the non-volatile memory cells can be configured as a single-level cell (SLC) or multiple-level memory cell. A single-level cell can store one bit of information per cell. A multiple-level memory cell can store more than one bit of information per cell. For example, each of the memory cells in the memory areas 102, 104, 106, and 108 can be configured as a multi-level cell (MLC) to store two bits of information per cell, a triple-level cell (TLC) to store three bits of information per cell, or a quad-level cells (QLC) to store four bits of information per cell. In another example, each of the memory cells in memory area 102, 104, 106, and 108 can be configured to store at least one bit of information (e.g., one bit of information or multiple bits of information), and each of the memory cells in memory area 102, 104, 106, and 108 can be configured to store more than one bit of information.

As shown in FIG. 1, the memory system 100 includes a controller module 120. The controller module 120 includes a memory interface 121 to communicate with the memory module 110, a host interface 126 to communicate with a host (not shown), a processor 124 to execute firmware-level code, and caches and memories 123 and 122, respectively to temporarily or persistently store executable firmware/instructions and associated information. In some implementations, the controller unit 120 can include an error correction engine 125 to perform error correction operation on information stored in the memory module 110. Error correction engine 125 can be configured to detect/correct single bit error or multiple bit errors. In another implementation, error correction engine 125 can be located in the memory module 110.

The host can be a device or a system that includes one or more processors that operate to retrieve data from the memory system 100 or store or write data into the memory system 100. In some implementations, examples of the host can include a personal computer (PC), a portable digital device, a digital camera, a digital multimedia player, a television, and a wireless communication device.

In some implementations, the controller module 120 can also include a host interface 126 to communicate with the host. Host interface 126 can include components that comply with at least one of host interface specifications, including but not limited to, Serial Advanced Technology Attachment (SATA), Serial Attached Small Computer System Interface (SAS) specification, Peripheral Component Interconnect Express (PCIe).

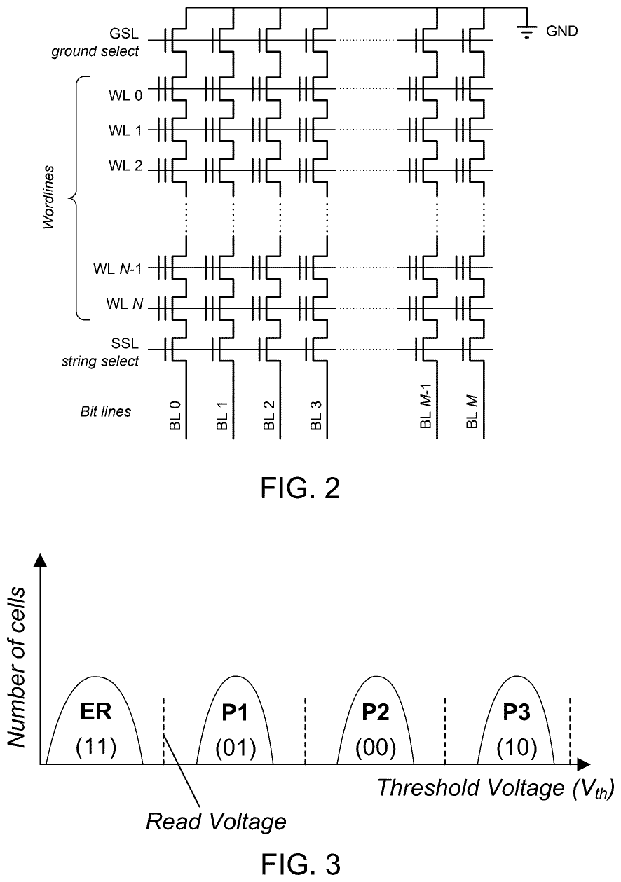

FIG. 2 illustrates an example of a memory cell array implemented based on some embodiments of the disclosed technology.

In some implementations, the memory cell array can include NAND flash memory array that is partitioned into many blocks, and each block contains a certain number of pages. Each block includes a plurality of memory cell strings, and each memory cell string includes a plurality of memory cells.

In some implementations where the memory cell array is NAND flash memory array, read and write (program) operations are performed on a page basis, and erase operations are performed on a block basis. All the memory cells within the same block must be erased at the same time before performing a program operation on any page included in the block. In an implementation, NAND flash memories may use an even/odd bit-line structure. In another implementation, NAND flash memories may use an all-bit-line structure. In the even/odd bit-line structure, even and odd bit-lines are interleaved along each word-line and are alternatively accessed so that each pair of even and odd bit-lines can share peripheral circuits such as page buffers. In all-bit-line structure, all the bit-lines are accessed at the same time.

FIG. 3 illustrates an example of threshold voltage distribution curves in a multi-level cell device, wherein the number of cells for each program/erase state is plotted as a function of the threshold voltage. As illustrated therein, the threshold voltage distribution curves include the erase state (denoted “ER” and corresponding to “11”) with the lowest threshold voltage, and three program states (denoted “P1”, “P2” and “P3” corresponding to “01”, “00” and “10”, respectively) with read voltages in between the states (denoted by the dotted lines). In some embodiments, each of the threshold voltage distributions of program/erase states has a finite width because of differences in material properties across the memory array.

Although FIG. 3 shows a multi-level cell device by way of example, each of the memory cells can be configured to store any number of bits per cell. In some implementations, each of the memory cells can be configured as a single-level cell (SLC) to store one bit of information per cell, or as a triple-level cell (TLC) to store three bits of information per cell, or as a quad-level cells (QLC) to store four bits of information per cell.

In writing more than one data bit in a memory cell, fine placement of the threshold voltage levels of memory cells is needed because of the reduced distance between adjacent distributions. This is achieved by using incremental step pulse program (ISPP), i.e., memory cells on the same word-line are repeatedly programmed using a program-and-verify approach with a staircase program voltage applied to word-lines. Each programmed state associates with a verify voltage that is used in verify operations and sets the target position of each threshold voltage distribution window.

Read errors can be caused by distorted or overlapped threshold voltage distribution. An ideal memory cell threshold voltage distribution can be significantly distorted or overlapped due to, e.g., program and erase (P/E) cycle, cell-to-cell interference, and data retention errors, which will be discussed in the following, and such read errors may be managed in most situations by using error correction codes (ECCs).

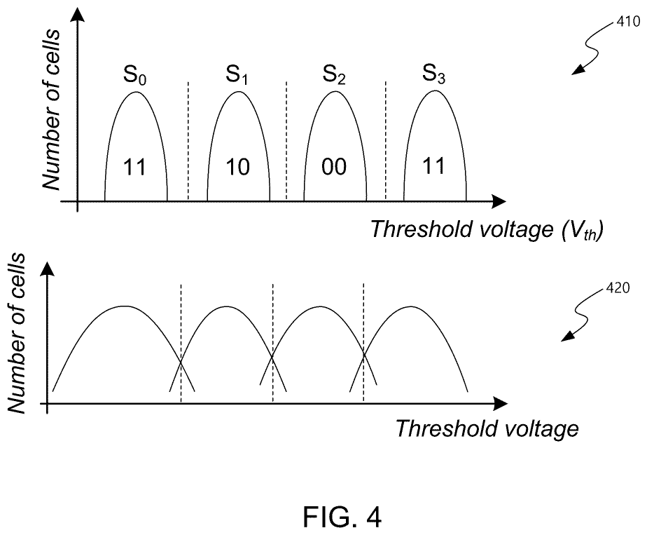

FIG. 4 illustrates an example of ideal threshold voltage distribution curves 410 and an example of distorted threshold voltage distribution curves 420. The vertical axis indicates the number of memory cells that has a particular threshold voltage represented on the horizontal axis.

For n-bit multi-level cell NAND flash memory, the threshold voltage of each cell can be programmed to 2ⁿ possible values. In an ideal multi-level cell NAND flash memory, each value corresponds to a non-overlapping threshold voltage window.

Flash memory P/E cycling causes damage to a tunnel oxide of floating gate of a charge trapping layer of cell transistors, which results in threshold voltage shift and thus gradually degrades memory device noise margin. As P/E cycles increase, the margin between neighboring distributions of different programmed states decreases and eventually the distributions start overlapping. The data bit stored in a memory cell with a threshold voltage programmed in the overlapping range of the neighboring distributions may be misjudged as a value other than the original targeted value.

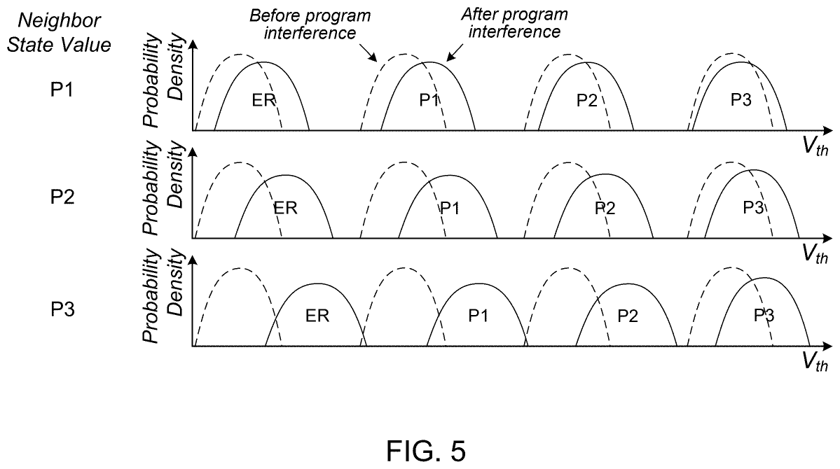

FIG. 5 illustrates an example of a cell-to-cell interference in NAND flash memory. The cell-to-cell interference can also cause threshold voltages of flash cells to be distorted. The threshold voltage shift of one memory cell transistor can influence the threshold voltage of its adjacent memory cell transistor through parasitic capacitance-coupling effect between the interfering cell and the victim cell. The amount of the cell-to-cell interference may be affected by NAND flash memory bit-line structure. In the even/odd bit-line structure, memory cells on one word-line are alternatively connected to even and odd bit-lines and even cells are programmed ahead of odd cells in the same word-line. Therefore, even cells and odd cells experience different amount of cell-to-cell interference. Cells in all-bit-line structure suffer less cell-to-cell interference than even cells in the even/odd bit-line structure, and the all-bit-line structure can effectively support high-speed current sensing to improve the memory read and verify speed.

The dotted lines in FIG. 5 denote the nominal distributions of P/E states (before program interference) of the cells under consideration, and the “neighbor state value” denotes the value that the neighboring state has been programmed to. As illustrated in FIG. 5, if the neighboring state is programmed to P1, the threshold voltage distributions of the cells under consideration shift by a specific amount. However, if the neighboring state is programmed to P2, which has a higher threshold voltage than P1, that results in a greater shift compared to the neighboring state being P1. Similarly, the shift in the threshold voltage distributions is greatest when the neighboring state is programmed to P3.

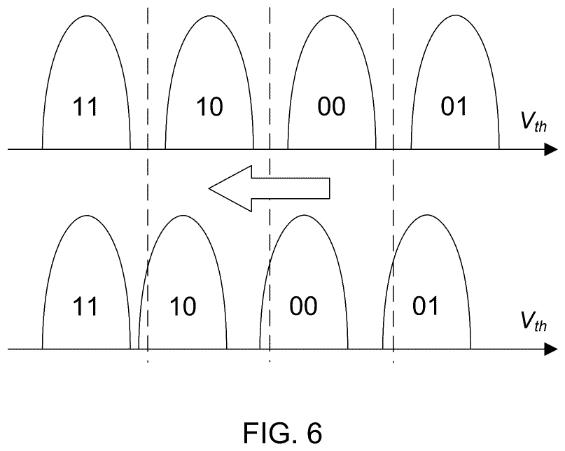

FIG. 6 illustrates an example of a retention error in NAND flash memory by comparing normal threshold-voltage distribution and shifted threshold-voltage distribution. The data stored in NAND flash memories tend to get corrupted over time and this is known as a data retention error. Retention errors are caused by loss of charge stored in the floating gate or charge trap layer of the cell transistor. Due to wear of the floating gate or charge trap layer, memory cells with more program erase cycles are more likely to experience retention errors. In the example of FIG. 6, comparing the top row of voltage distributions (before corruption) and the bottom row of distributions (contaminated by retention error) reveals a shift to the left.

In the NAND flash memory examples described above, a “hard read” is an operation to determine hard information such as by comparing the threshold voltage of a memory cell, e.g., flash memory cell, to reference voltages delineating ranges of voltages corresponding to particular states. A hard read can be full-confidence sensing, e.g., sensing that does not involve other information about the digits of the data value such as confidence. That is, the data value sensed from the memory cell is assumed to be the data value that was programmed to the memory. For full-confidence sensing, a digit of a data value that is sensed, e.g., read from memory, as a “0” will have a corresponding LLR of +1, and a data value that is sensed as a “1” can have a corresponding LLR of −1.

Furthermore, the example NAND-based storage systems discussed above use low-density parity check (LDPC) codes, which are a type of error-correcting code used to ensure data integrity in non-volatile memory (NVM) devices, such as flash memory. The encoding process begins by dividing the original data into blocks of a fixed size. A sparse parity-check matrix is then used to generate parity bits, which are combined with the data bits to form a codeword. This codeword is stored in the non-volatile memory, which retains data even when power is lost.

When data is read from the non-volatile memory, it may contain errors due to various factors like wear and tear of the memory cells or environmental conditions. A defense hierarchy (or defense flow) implemented in firmware may include multiple stages that the firmware traverses through while attempting to recover the data with bit errors. For example, a defense hierarchy may include multiple defense algorithms including History Read that attempts to read the data using the last successful read parameters, Read Retry that attempts to read the data using modified read params, eBoost that attempts to find the optimal read reference voltage, as well as other defense algorithms. In this example, if the History Read stage fails to recover the error, the firmware proceeds to the Read Retry stage. If the Read Retry stage cannot recover the error, the firmware invokes the eBoost algorithm, and so on. Different stages of the defense hierarchy can have their own firmware flows, ways to interact with hardware, and error correction capabilities. The purpose of applying the defense algorithms is to recover the data that could not be read after the first attempt. There can be several stages of defense algorithms, and each defense algorithm can also initiate several attempts or retries to read the data from the memory device. The number of reads within each defense stage need not be fixed in advance, and may vary depending on different physical processes.

In the case of defense algorithms that rely on ECCs, e.g., LDPC codes, the LDPC codes detect and correct these errors through a process that involves calculating a syndrome by multiplying the read codeword by the transpose of the parity-check matrix (typically denoted H). If the syndrome is non-zero, it indicates the presence of errors. An iterative decoding algorithm (e.g., the belief propagation algorithm) is then used to correct the errors. This algorithm iteratively updates probabilities of each bit being 0 or 1 by passing messages between variable nodes and check nodes in a bipartite graph until the probabilities converge to stable values, resulting in the corrected codeword and the extraction of the original data.

For an LDPC code with m×n parity-check matrix H, a checksum (CS) computation of a length-n noisy codeword r is determined by computing the syndrome (SYND) as follows:

$$SYND = {rH}^{T} .$$

Herein, the T subscript represents the transpose operation, and the checksum is the number of ones in SYND.

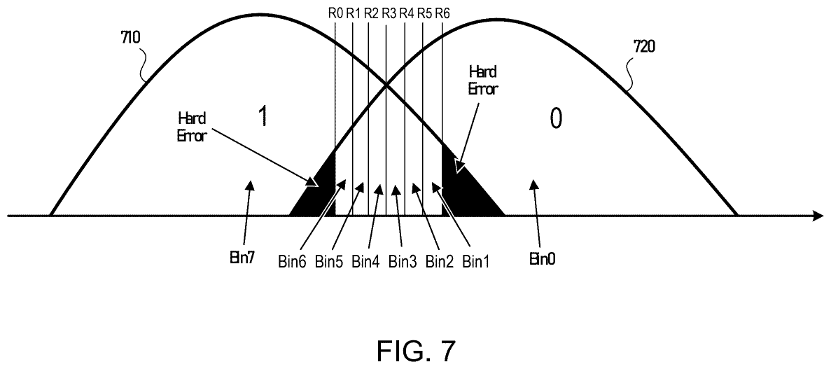

In some embodiments, the soft read channels of a single-level cell (SLC) NAND, which are illustrated in FIG. 7, are considered. As shown therein, the seven read channels {R0, R1, . . . , R6}divide the entire voltage range into eight bins, labeled Bin0, Bin1, . . . , Bin7. The curves 710 and 720 in FIG. 7 represent the probability density functions (PDFs) of the actual voltage distribution of the corresponding written voltage.

As shown in FIG. 7, the left curve 710 corresponds to written value 1, the right curve 720 corresponds to written value 0, and the probability of writing a value 0 and a value 1 are assumed to be the same. The 7 thresholds divide the area under curves into eight parts, namely Bin0, Bin1, Bin2, Bin3, . . . , Bin7. The notation y=Bin0, Bin1, . . . , Bin7 (or simply y=0, 1, 2, . . . , 7) is used to represent the event where the read result falls into the respective bin, e.g., Biny; this representation is referred to as a bin label. Furthermore, x=0 and x=1 is used to represent the originally stored information as being a 0 or 1, respectively, and corresponding to the left PDF and right PDF. Accordingly, the log-likelihood ratio (LLR) of Bin i (with i=0, . . . , 7) is defined as:

$$LLR ( i ) = log ( \frac{p ( y = i \vert x = 0 )}{p ( y = i \vert x = 1 )} ) .$$

Herein, LLR(0) (or simply LLR0) is the log-likelihood ratio metric for a bit being zero-valued, whereas LLR1 is the LLR metric for a bit being one-valued. In the above-described framework, hard errors are defined as cell bits that fall out of the soft range with wrong sign. In FIG. 7, the area corresponding to a hard error is the union of the two regions labeled “Hard Error”. Consequently, both Bin0 and Bin7 are referred to as hard error bins.

In NAND-based storage systems (e.g., the examples illustrated in FIGS. 1-6) and solid-state drive (SSD) applications, hard errors have a significant impact on the LDPC soft decoding correction capability in the memory device. Hard errors from the NAND flash memory channel are defined as erroneous bits with wrong sign and maximal magnitude.

In currently existing defense flows, the first few reads are all using LDPC hard decoding. For the case of a quad-level cell (QLC) NAND, which has very small read margins, there is a high probability that all these first few reads return high fail bit count (FBC) values and cause hard decoding failures. Embodiments of the disclosed technology are directed to methods and systems for generating log-likelihood ratio (LLR) metrics by utilizing the information from the previous hard reads for soft decoding (e.g., bit sequences of previous hard reads, their ones count, and their checksums), thereby improving the correction capability of the LDPC decoder.

In some embodiments, for each hard bit sequence per read, a corresponding LLR sequence is generated based on (a) the CS of the bit sequence, or (b) both the CS and ones count of the bit sequence. Then, a combined LLR sequence is generated for LDPC soft decoding based on a mapping (or function). The described embodiments enable the combined LLR to be generated and decoded progressively, as part of the first few steps in the defense flow. The associated latency penalty is minimal, since only additional soft decoding iterations (which can be very fast) are needed without triggering any additional NAND reads. Unlike conventional LLR generation algorithm, the described embodiments do not require the hard reads to be in any predetermined order.

In some embodiments, the following procedure can be used to generate a combined LLR based on multiple hard reads.
(A1) Perform m NAND reads to obtain m noisy codewords CW1=(X1₀, X1₁, . . . , X1ₙ₋₁), CW2=(X2₀, X2₁, . . . , X2ₙ₋₁), . . . , CWm=(Xm₀, Xm₁, . . . , Xmₙ₋₁). Each codeword has a length of n, and each element of CW is either 0 or 1.
(A2) For each codeword, calculate its checksum (denoted by CS1, CS2, . . . , CSm).
(A3) For each codeword, generate a corresponding LLR sequence, denoted by LLR_SEQ1=(L1₀, L1₁, . . . , L1ₙ₋₁), LLR_SEQ2=(L2₀, L2₁, . . . , L2ₙ₋₁), . . . , LLR_SEQm=(Lm₀, Lm₁, . . . , Lmₙ₋₁), based on the following pseudocode:

```
FOR i = 1 to m
  Retrieve (LLR0, LLR1) from Table 1 using the checksum, CSi
  FOR j = 0 to (n − 1)
    IF Xiⱼ == 0: Liⱼ = LLR0
    ELSE Liⱼ = LLR1
  END
END
```

(A4) Generate the combined LLR sequence LLR_COMB=(L₀, L₁, . . . , Lₙ₋₁) by combining LLR_SEQ1, LLR_SEQ2, and LLR_SEQm based on the following pseudocode:

FOR i = 0 to (n − 1)
Lᵢ = F (L1ᵢ, L2ᵢ, ..., Lmᵢ)
END

Herein, Table 1 (shown as part of the numerical example that follows) is a look-up table (LUT) that maps a checksum value (in the range zero (0) to infinity (INF)) to LLR metrics for zero-valued bits and one-valued bits, e.g., LLR0=K and LLR1=−K, with K being a positive integer. In this example, the LLR metrics have equal magnitudes and different signs. In other examples, LLR0 and LLR1 have opposite signs and unequal magnitudes, e.g., based on an imbalance in the number of ones in the codewords.

In some embodiments, the function F(·) used in operation (A4) is a function with a restricted output range, e.g., [−7, 7](or more generally, [−(2^{K}−1), 2^{K}−1]). In some examples, the function F(·) can be an averaging operation, e.g.,

$${L}_{i} = Round ( \frac{1}{m} \cdot ( L {1}_{i} + L {2}_{i} + … + {Lm}_{i} ) ) .$$

If we denote the (m-1)-th combined LLR as LLR_COMB(m-1) and the m-th combined LLR as LLR_COMB(m), then the current combined LLR can be computed from the previous combined LLR and the most recent hard read (denoted LLR_SEQm) based on the following iterative computation:

$$LLR\_COMB ( m ) = Round ( ( 1 / m ) \times ( ( m - 1 ) \times LLR\_COMB ( m - 1 ) + LLR\_SEQm ) ) .$$

The above computation enables the combined LLR to be progressively computed, in an efficient manner, each time a bit sequence from a hard read becomes available. This also enables certain bit sequences to be rejected, which is discussed later.

In some embodiments, an example of generating a combined LLR assumes there are three noisy codewords with corresponding checksums as follows:

$$\begin{matrix}CW 1 = [ 1 , 1 , 0 , 0 , … , … , 1 , 0 ] , CS 1 = 1500 \\ CW 2 = [ 1 , 1 , 1 , 0 , … , … , 1 , 0 ] , CS 2 = 1600 \\ CW 3 = [ 1 , 0 , 1 , 0 , … , … , 1 , 1 ] , CS 3 = 2300\end{matrix}$$

Using Table 1, which maps an input checksum to an output pair of LLR metrics (e.g., LLR0 and LLR1), the following LLR sequences can be generated:

$$\begin{matrix}LLR\_SEQ1 = [ - 4 , - 4 , 4 , 4 , … , … , - 4 , 4 ] \\ LLR\_SEQ2 = [ - 4 , - 4 , - 4 , 4 , … , … , - 4 , 4 ] \\ LLR\_SEQ3 = [ - 3 , 3 , - 3 , 3 , … , … , - 3 , - 3 ]\end{matrix}$$

The combined LLR is generated by combining the above LLR sequences, e.g., using an averaging function F( ) as discussed above, which results in:

$$LLR\_COMB = [ - 4 , - 2 , - 1 , 4 , … , … , - 4 , 2 ]$$

TABLE 1
Example look-up table for CS → (LLR0, LLR1)

| CS | (LLR0, LLR1) |
|---|---|
| [0, 1400) | (5, −5) |
| [1400, 2200) | (4, −4) |
| [2200, INF) | (3, −3) |

In some embodiments, the ones count for each noisy codeword (e.g., the number of one-valued bits in the codeword) is also available, and this information can be incorporated into the procedure to generate the combined LLR. In particular, operations (A2) and (A3) can be modified as shown below.
(A2′) For each codeword, calculate its checksum (denoted CS1, CS2, . . . , CSm) and its ones count (denoted OC1, OC2, . . . , OCm).
(A3′) For each codeword, generate a corresponding LLR sequence, denoted by LLR_SEQ1=(L1₀, L1₁, . . . , L1ₙ₋₁), LLR_SEQ2=(L2₀, L2₁, . . . , L2ₙ₋₁), . . . , LLR_SEQm=(Lm₀, Lm₁, . . . , Lmₙ₋₁), based on the following pseudocode:

```
FOR i = 1 to m
  Retrieve (LLR0, LLR1) from Table 2 using CSi and OCi
  FOR j = 0 to (n − 1)
    IF Xiⱼ == 0: Liⱼ = LLR0
    ELSE Liⱼ = LLR1
  END
END
```

Herein, Table 2 (shown below) is a LUT that maps a checksum value (in the range zero (0) to infinity (INF)) and a ones count value (in the range −INF to INF) to LLR metrics for zero-valued bits and one-valued bits, e.g., LLR0 and LLR1.

TABLE 2
Example look-up table for (CS, OC) → (LLR0, LLR1)

| CS/OC | [280, +INF) | [100, 280) | [−100, 100) | [−280, −100) | [−INF, −280) |
|---|---|---|---|---|---|
| [0, 1400) | (7, −4) | (5, −4) | (5, −5) | (4, −5) | (4, −7) |
| CS/OC | [560, +INF) | [200, 560) | [−200, 200) | [−560, −200) | [−INF, −560) |
| [1400, 2200) | (6, −3) | (5, −3) | (4, −4) | (3, −5) | (3, −6) |
| CS/OC | [800, +INF) | [300, 800) | [−300, 300) | [−800, −300) | [−INF, −800) |
| [2200, INF) | (6, −3) | (4, −3) | (3, −3) | (3, −4) | (3, −6) |

In the above LUT, the input checksum value will select a row of Table 2, and the input ones count will select the appropriate column in that row, which provides the LLR metrics (e.g., LLR0 and LLR1) used for those input values.

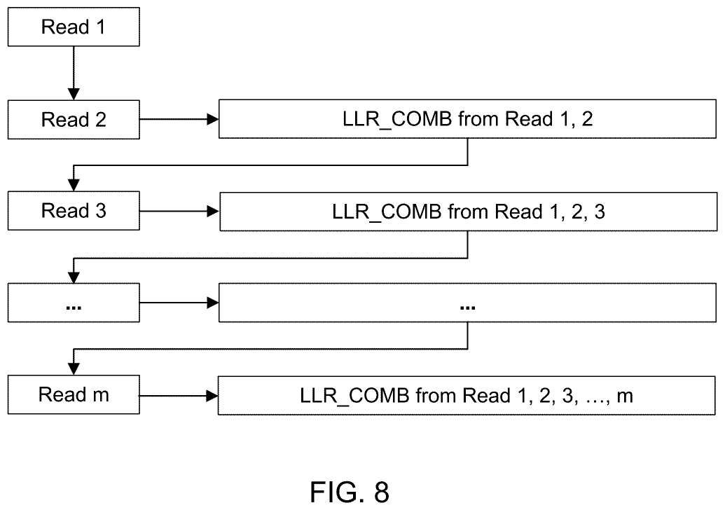

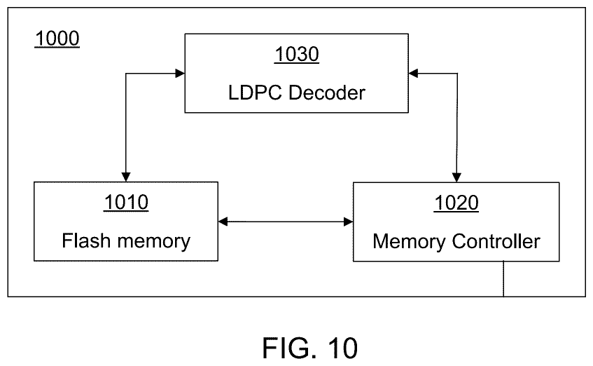

In some embodiments, an example workflow for progressive LLR generation and decoding is shown in FIG. 8. As shown therein, when a read command (“Read 1”) arrives at a memory controller (e.g., memory controller 1020 shown in FIG. 10), it performs a first hard read (e.g., from flash memory 1010 in FIG. 10) and a decoding operation (e.g., using LDPC decoder 1030 in FIG. 10). If the decoding operation succeeds, the next read command will be processed. Otherwise, a second hard read (“Read 2”) is performed. If it succeeds, the next read command will be processed. Otherwise, a combined LLR based on the first two hard reads (e.g., LLR_COMB based on Read 1 and Read 2) is generated and used to perform soft decoding. For the third hard read (“Read 3”) and subsequent hard reads, the combined LLR can be generated iteratively as discussed above.

In some embodiments, existing bin labels and LLR generation system-on-chip (SoC) intellectual property (IP) can be leveraged to generate LLR values with minimal impact to existing hardware configurations. For example, to combine m hard reads, a bin label sequence is first generated by bitwise-adding the m bit sequences from the m hard reads. Each element of the resulting bin label sequence belongs to [0, 1, 2, . . . , m]. Then, an LLR sequence is generated by assigning a value to each bin label of the bin label sequence based on a predesigned LUT, e.g., Table 3 shown below that maps an input bin label to a corresponding output LLR metric.

TABLE 3
Example look-up table for bin label → LLR

| Bin Label | LLR Value |
|---|---|
| 0 | LLR0 |
| 1 | LLR1 |
| 2 | LLR2 |
| . . . | . . . |
| m | LLRm |

In illustrative numerical examples, the two and three hard reads scenarios (which have minimal latency, yet can provide measurable correction gains) are considered.

When two hard reads are considered, the bin label sequence is first generated by bitwise-adding the bit sequences from the two hard reads, e.g.,

$$\begin{matrix}RD 1 : ( 11100 , … … 101 ) \\ + RD 2 : ( 10110 , … … 011 ) \\ Bin Label : ( 21210 , … … 112 )\end{matrix}$$

Then, assuming Table 3 for this case specifies (LLR0=4, LLR1=0, LLR2=−4), the corresponding LLR sequence for the bin label sequence above will be:

$$LLR : ( - 40 - 404 , … … 00 - 4 )$$

When three hard reads are considered, the bin label sequence is first generated by bitwise-adding the bit sequences from the two hard reads, e.g.,

$$\begin{matrix}RD 1 : ( 11100 , … … 101 ) \\ + RD 1 : ( 10110 , … … 011 ) \\ + RD 3 : ( 10100 , … … 100 ) \\ Bin Label : ( 31310 , … … 212 )\end{matrix}$$

Then, assuming Table 3 for this case specifies (LLR0=4, LLR1=1, LLR2=−1, LLR3=−4), the corresponding LLR sequence for the bin label sequence above will be:

$$LLR : ( - 41 - 414 , … … - 11 - 1 )$$

In some embodiments, and as alluded to earlier, all existing hard reads do not need to be combined to generated the combined LLR. In these read selection policies, bit sequences from certain hard reads are rejected based on one or more characteristics of the hard read.

In some examples, the fact that the magnitude of LLR0 and/or LLR1 is inversely proportional to the CS value (e.g., when the CS is high, there are more errors, and estimation of the LLRs are less reliable) is leveraged. In these examples, hard reads with large checksum values are rejected, e.g., checksum values that are larger than a predetermined threshold. For example, the threshold predetermined is equal to 2000.

In other examples, the threshold value depends on the type of NAND cell (e.g., QLC or TLC) since each type of NAND cell typically uses a different LDPC code, which results in different parity matrices being used, but is independent of the ones count.

In yet other examples, hard reads can be selected based on their read biases being separated by a predetermined value (or threshold), e.g., a distance metric based on the absolute value of the difference of two read biases is greater than a threshold value (e.g., β=0.02V). For an example LSB page that has two read thresholds, first consider two hard reads LSB_RD1=(0.50V, 3.40V) and LSB_RD2=(0.54V, 3.00V). In this first case, the LSB reads satisfy this condition because each of |0.50-0.54| and |3.40-3.00| is greater than 0.02. Alternatively, in a second case, two hard reads LSB_RD1=(0.52V, 3.4V) and LSB_RD2=(0.52V, 3.0V) do not satisfy the condition because |0.52-0.52| is less than 0.02, and thus at least one of them is rejected. Using this characteristic leverages the fact that if two hard reads are extremely close, they will likely provide similar or redundant information. Furthermore, alternative distance metrics can be used to reject hard reads. These selection criteria can be directly applied to CSB and MSB pages.

As discussed above, the read selection policies produce more reliable combined LLR values because hard reads associated with larger errors (e.g., high checksum values) or redundant information (e.g., very similar read biases) are eliminated from the computations.

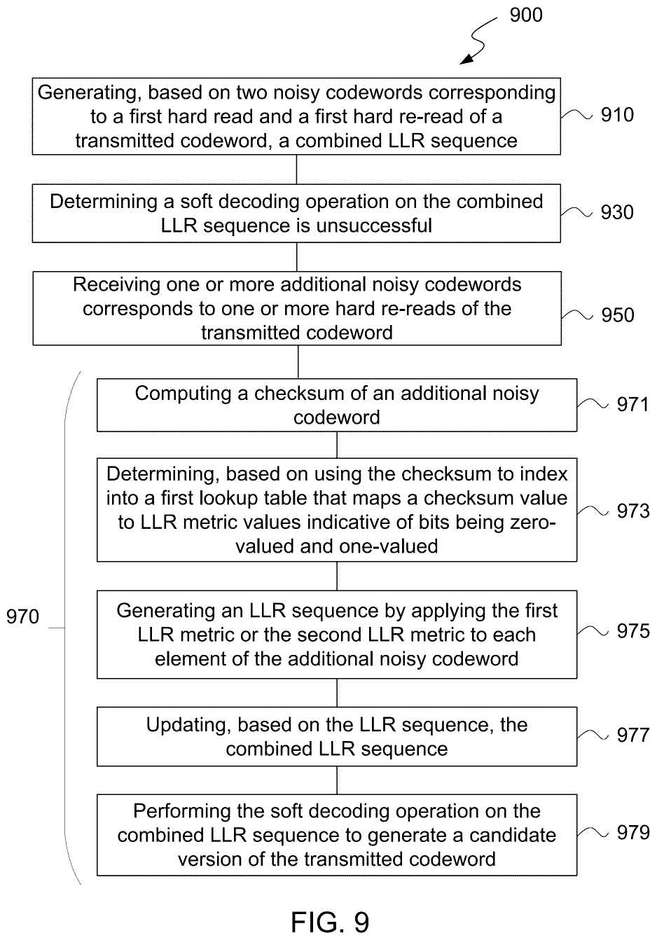

FIG. 9 illustrates a flowchart of an example method 900 for improving the performance of a decoder in a memory device. The method 900 includes, at operation 910, generating, based on two noisy codewords corresponding to a first hard read and a first hard re-read of a transmitted codeword, a combined LLR sequence.

The method 900 includes, at operation 930, determining a soft decoding operation on the combined LLR sequence is unsuccessful.

The method 900 includes, at operation 950, receiving one or more additional noisy codewords corresponds to one or more hard re-reads of the transmitted codeword.

The method 900 includes, at operation 970, performing operations 971 to 979 for each additional noisy codeword in the one or more additional noisy codewords.

The method 900 includes, at operation 971, computing a checksum of an additional noisy codeword.

The method 900 includes, at operation 973, determining, based on using the checksum to index into a first lookup table that maps a checksum value to LLR metric values indicative of bits being zero-valued and one-valued.

The method 900 includes, at operation 975, generating an LLR sequence by applying the first LLR metric or the second LLR metric to each element of the additional noisy codeword.

The method 900 includes, at operation 977, updating, based on the LLR sequence, the combined LLR sequence.

The method 900 includes, at operation 979, performing the soft decoding operation on the combined LLR sequence to generate a candidate version of the transmitted codeword.

In some embodiments, the method 900 further includes, for each additional noisy codeword, computing a ones count of the additional noisy codeword, wherein the checksum and the ones count are jointly used to index into a second lookup table, which maps a checksum value and a ones count value pair to the LLR metric values, to determine the first LLR metric and the second LLR metric.

In some embodiments, determining the soft decoding operation is unsuccessful includes performing the soft decoding operation on the combined LLR sequence to generate an initial candidate version of the transmitted codeword, and determining that the initial candidate version of the transmitted codeword is not equal to the transmitted codeword.

In some embodiments, updating the combined LLR sequence includes computing a weighted average of the combined LLR sequence and the LLR sequence. In some examples, weight values used in the weighted average are based on a number of the one or more additional noisy codewords.

In some embodiments, generating the combined LLR sequence includes generating a sequence based on computing a bit-wise summation of the two noisy codewords, wherein elements of the sequence are between 0 and M, where M is a positive integer, and generating each LLR of the combined LLR sequence based on using a respective element of the sequence to index into a second lookup table that maps a sequence element to a combined LLR value.

In some embodiments, operations 973 through 979 are performed in response to the checksum of the additional noisy codeword not exceeding a threshold value.

In some embodiments, operations 973 through 979 are performed in response to an absolute difference between a read bias of a current hard re-read of the one or more additional noisy codewords and a read bias of a previous hard re-read of the one or more additional noisy codewords exceeding a threshold voltage value.

In some embodiments, the transmitted codeword corresponds to a low-density parity-check (LDPC) code, the checksum is a number of one-valued entries of a syndrome, and the syndrome is determined based on a product of the additional noisy codeword and a transpose of a parity check matrix of the LDPC code.

FIG. 10 is an example diagram illustrating a storage device that can be configured to implement the described embodiments. Referring to FIG. 10, a data storage device 1000 may include a flash memory 1010, a memory controller 1020, and an LDPC decoder 1030. The memory controller 1020 may control the flash memory 1010 and the LDPC decoder 1030 in response to control signals input from the outside of the data storage device 1000. In the data storage device 1000, the flash memory 1010 may be configured the same or substantially the same as a nonvolatile memory device. That is, the flash memory 1010 may read data from selected memory cells using different read voltages to output it to the memory controller 1020.

In some embodiments, the data storage device 1000 may be a memory card device, an SSD device, a multimedia card device, an SD card, a memory stick device, an HDD device, a hybrid drive device, or an USB flash device. For example, the data storage device 1000 may be a card which satisfies the standard for user devices such as a digital camera, a personal computer, and so on.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for improving a performance of a decoder in a memory device, comprising:
generating, based on two noisy codewords corresponding to a first hard read and a first hard re-read of a transmitted codeword, a combined log-likelihood ratio (LLR) sequence;
determining a soft decoding operation on the combined LLR sequence is unsuccessful;
receiving one or more additional noisy codewords, wherein each additional noisy codeword corresponds to another hard re-read of the transmitted codeword; and
for each additional noisy codeword in the one or more additional noisy codewords:
(a) computing a checksum of an additional noisy codeword;
(b) determining, based on using the checksum to index into a first lookup table that maps a checksum value to LLR metric values, a first LLR metric indicative of a bit being zero-valued and a second LLR metric indicative of the bit being one-valued;
(c) generating an LLR sequence by applying the first LLR metric or the second LLR metric to each element of the additional noisy codeword;
(d) updating, based on the LLR sequence, the combined LLR sequence; and
(e) performing the soft decoding operation on the combined LLR sequence to generate a candidate version of the transmitted codeword.

2. The method of claim 1, wherein, for each additional noisy codeword, the method comprises:
computing a ones count of the additional noisy codeword, wherein the checksum and the ones count are jointly used to index into a second lookup table, which maps a checksum value and a ones count value pair to the LLR metric values, to determine the first LLR metric and the second LLR metric.

3. The method of claim 1, wherein determining the soft decoding operation is unsuccessful comprises:
performing the soft decoding operation on the combined LLR sequence to generate an initial candidate version of the transmitted codeword; and
determining that the initial candidate version of the transmitted codeword is not equal to the transmitted codeword.

4. The method of claim 1, wherein updating the combined LLR sequence comprises:
computing a weighted average of the combined LLR sequence and the LLR sequence, wherein weight values used in the weighted average are based on a number of the one or more additional noisy codewords.

5. The method of claim 1, wherein generating the combined LLR sequence comprises:
generating a sequence based on computing a bit-wise summation of the two noisy codewords, wherein elements of the sequence are between 0 and M, where M is a positive integer; and
generating each LLR of the combined LLR sequence based on using a respective element of the sequence to index into a second lookup table that maps a sequence element to a combined LLR value.

6. The method of claim 1, wherein steps (b) through (e) are performed in response to the checksum of the additional noisy codeword not exceeding a threshold value.

7. The method of claim 1, wherein steps (b) through (e) are performed in response to an absolute difference between a read bias of a current hard re-read of the one or more additional noisy codewords and a read bias of a previous hard re-read of the one or more additional noisy codewords exceeding a threshold voltage value.

8. The method of claim 1, wherein the transmitted codeword corresponds to a low-density parity-check (LDPC) code, wherein the checksum is a number of one-valued entries of a syndrome, and wherein the syndrome is determined based on a product of the additional noisy codeword and a transpose of a parity check matrix of the LDPC code.

9. A system for improving a performance of a decoder in a memory device, comprising:
one or more processors and a memory including instructions stored thereupon, wherein the instructions upon execution by the one or more processors cause the one or more processors to:
generate, based on two noisy codewords corresponding to a first hard read and a first hard re-read of a transmitted codeword, a combined log-likelihood ratio (LLR) sequence;
determine a soft decoding operation on the combined LLR sequence is unsuccessful;
receive one or more additional noisy codewords, wherein each additional noisy codeword corresponds to another hard re-read of the transmitted codeword; and
for each additional noisy codeword in the one or more additional noisy codewords:
(a) compute a checksum of an additional noisy codeword;
(b) determine, based on using the checksum to index into a first lookup table that maps a checksum value to LLR metric values, a first LLR metric indicative of a bit being zero-valued and a second LLR metric indicative of the bit being one-valued;
(c) generate an LLR sequence by applying the first LLR metric or the second LLR metric to each element of the additional noisy codeword;
(d) update, based on the LLR sequence, the combined LLR sequence; and
(e) perform the soft decoding operation on the combined LLR sequence to generate a candidate version of the transmitted codeword.

10. The system of claim 9, wherein, for each additional noisy codeword, the one or more processors are caused to:
compute a ones count of the additional noisy codeword, wherein the checksum and the ones count are jointly used to index into a second lookup table, which maps a checksum value and a ones count value pair to the LLR metric values, to determine the first LLR metric and the second LLR metric.

11. The system of claim 9, wherein the one or more processors are caused, as part of determining the soft decoding operation is unsuccessful, to:
perform the soft decoding operation on the combined LLR sequence to generate an initial candidate version of the transmitted codeword; and
determine that the initial candidate version of the transmitted codeword is not equal to the transmitted codeword.

12. The system of claim 9, wherein the one or more processors are caused, as part of generating the combined LLR sequence, to:
generate a sequence based on computing a bit-wise summation of the two noisy codewords, wherein elements of the sequence are between 0 and M, where M is a positive integer; and
generate each LLR of the combined LLR sequence based on using a respective element of the sequence to index into a second lookup table that maps a sequence element to a combined LLR value.

13. The system of claim 9, wherein steps (b) through (e) are performed in response to the checksum of the additional noisy codeword not exceeding a threshold value.

14. The system of claim 9, wherein steps (b) through (e) are performed in response to an absolute difference between a read bias of a current hard re-read of the one or more additional noisy codewords and a read bias of a previous hard re-read of the one or more additional noisy codewords exceeding a threshold voltage value.

15. The system of claim 9, wherein the transmitted codeword corresponds to a low-density parity-check (LDPC) code, wherein the checksum is a number of one-valued entries of a syndrome, and wherein the syndrome is determined based on a product of the additional noisy codeword and a transpose of a parity check matrix of the LDPC code.

16. A non-transitory computer-readable storage medium having instructions stored thereupon for improving a performance of a decoder in a memory device, comprising:
instructions for generating, based on two noisy codewords corresponding to a first hard read and a first hard re-read of a transmitted codeword, a combined log-likelihood ratio (LLR) sequence;
instructions for determining a soft decoding operation on the combined LLR sequence is unsuccessful;
instructions for receiving one or more additional noisy codewords, wherein each additional noisy codeword corresponds to another hard re-read of the transmitted codeword; and
for each additional noisy codeword in the one or more additional noisy codewords:
(a) instructions for computing a checksum of an additional noisy codeword;
(b) instructions for determining, based on using the checksum to index into a first lookup table that maps a checksum value to LLR metric values, a first LLR metric indicative of a bit being zero-valued and a second LLR metric indicative of the bit being one-valued;
(c) instructions for generating an LLR sequence by applying the first LLR metric or the second LLR metric to each element of the additional noisy codeword;
(d) instructions for updating, based on the LLR sequence, the combined LLR sequence; and
(e) instructions for performing the soft decoding operation on the combined LLR sequence to generate a candidate version of the transmitted codeword.

17. The non-transitory computer-readable storage medium of claim 16, wherein steps (b) through (e) are performed in response to the checksum of the additional noisy codeword not exceeding a threshold value.

18. The non-transitory computer-readable storage medium of claim 16, wherein steps (b) through (e) are performed in response to an absolute difference between a read bias of a current hard re-read of the one or more additional noisy codewords and a read bias of a previous hard re-read of the one or more additional noisy codewords exceeding a threshold voltage value.

19. The non-transitory computer-readable storage medium of claim 16, wherein the transmitted codeword corresponds to a low-density parity-check (LDPC) code, wherein the checksum is a number of one-valued entries of a syndrome, and wherein the syndrome is determined based on a product of the additional noisy codeword and a transpose of a parity check matrix of the LDPC code.

20. The non-transitory computer-readable storage medium of claim 16, further comprising for each additional noisy codeword:
instructions for computing a ones count of the additional noisy codeword, wherein the checksum and the ones count are jointly used to index into a second lookup table, which maps a checksum value and a ones count value pair to the LLR metric values, to determine the first LLR metric and the second LLR metric.
